(19) United States
(12) Patent Application Publication
(10) Pub. No.: US 2002/0138643 A1
(43) Pub. Date: Sep. 26, 2002

(54) Method and system for controlling network traffic to a network computer

(76) Inventors: Kang G. Shin, (US); Hani Jamjoom, (US); John Reumann, (US)

Correspondence Address: David R. Syrowik, Brooks & Kushman P.C., 22nd Floor, 1000 Town Center, Southfield, MI, 48075-1351, US

(21) Appl. No.: 09/982,612

(22) Filed: Oct. 18, 2001

Related U.S. Application Data
(60) Provisional application No. 60/241,773, filed on Oct. 19, 2000.

(51) Int. Cl. G06F 15/16; G06F 15/173

(52) U.S. Cl. 709/232; 709/223

(57) ABSTRACT

A method and system for controlling network traffic to a network computer such as a server is provided wherein such control is provided based on a measured capacity of the server to service the network traffic and rule data which represents different policies for servicing the network traffic. A load-controller of the system installs more or less restrictive packet or request filtering policies based on the capacity of the server to throttle the traffic to the server. The method and system are sensitive to the actual capacity of the server by adopting this adaptive traffic-shaping feature instead of using rigid policies to control resource usage on the server.

### CROSS-REFERENCE TO RELATED APPLICATION

This application claims the benefit of U.S. provisional application Serial No. 60/241,773, filed Oct. 19, 2000 and entitled “Dynamic Filter Selection to Protect Internet Servers From Overload.”

### BACKGROUND OF THE INVENTION

1. Field of the Invention

This invention relates to methods and systems for controlling network traffic to a network computer.

2. Background Art

A server is a computation device or a cluster of cooperating computational devices that provide service to other computers or users that are connected to the server by a communication network. A packet as described herein represents any unit of information that is sent from the client to the server or the server to the client over a communication network.

Current operating systems are not well-equipped to handle sudden load surges that are commonly experienced by servers such as Internet servers. This means that service providers and customers may not be able to count on servers being available once their content becomes very popular. Recent Denial-of-Service attacks on major e-commerce sites have capitalized on this weakness.

For example, recent blackouts of major websites, such as Yahoo, ebay, and E*Trade, demonstrated how susceptible e-business is to simple Denial-of-Service (DoS) attacks. Using publicly available software, amateur hackers can choose from a variety of attacks such as SYN or ping-floods to lock out paying customers. These attacks either flood the network pipe with traffic or pound the server with requests, thus exhausting precious server resources. In both attack scenarios, the server will appear dead to its paying (or otherwise important) customers.

This problem has been known since the early 1980's. Since then, various fixes have been proposed. Nevertheless, these fixes are only an insufficient answer to the challenges faced by service providers today. What makes things more difficult today is that service providers want to differentiate between their important and less important clients at all times, even while drawing fire from a DoS attack.

The recent DoS attacks are only one instance of poorly managed overload scenarios. A sudden load surge, too, can lead to a significant deterioration of service quality (QoS)—sometimes coming close to the denial of service. Under such circumstances, important clients' response time may increase drastically. More severe consequences may follow if the amount of work-in-progress causes hard OS resource limits to be violated. If such failures were not considered in the design of the service, the service may crash, thus potentially leading to data loss.

These problems are particularly troubling for sites that offer price-based service differentiation. Depending on how much customers pay for the service, they have different QoS requirements. First of all, paying customers want the system to remain available even when it is heavily loaded. Secondly, higher-paying customers wish to see their work requests take priority over lower-paying customers when resources are scarce. For example, a website may offer its content to paying customers as well as free-riders. A natural response to overload is not to serve content to the free-riders. However, this behavior cannot be configured in current server Oss.

Although pure middleware solutions for QoS differentiation exist, they fail when the overload occurs before incoming requests are picked up and managed by the middleware. Moreover, middleware solutions fail when applications bypass the middleware's control mechanism, e.g., by using their own service-specific communication primitives or simply by binding communication libraries statically. Therefore, much attention has been focused on providing strong performance management mechanisms in the OS and network subsystem. However, these solutions introduce more controls than necessary to manage QoS differentiation and defend the server from overload.

A number of commercial and research projects address the problem of server overload containment and differential QoS. Ongoing research in this field can be grouped into three major categories: adaptive middleware, OS, and network-centric solutions.

Middleware for QoS Differentiation

Middleware solutions coordinate graceful degradation across multiple resource-sharing applications under overload. Since the middleware itself has only little control over the load of the system, they rely on monitoring feedback from the OS and application cooperation to make their adaptation choices. Middleware solutions work only if the managed applications are cooperative (e.g., by binding to special communication libraries).

IBM's workload manager (WLM) is the most comprehensive middleware QoS management solution. WLM provides insulation for competing applications and capacity management. It also provides response time management, thus allowing the administrator to simply specify target response times for each application. WLM will manage resources in such a way that these target response times are achieved. However, WLM relies heavily on strong kernel-based resource reservation primitives, such as I/O priorities and CPU shares to accomplish its goals. Such rich resource management support is only found in resource rich mainframe environments. Therefore, its design is not generally applicable to small or mid-sized servers. Moreover, WLM requires server applications to be well-aware. WebQoS models itself after WLM but requires fewer application changes and weaker OS support. Nevertheless, it depends on applications binding to the system's dynamic communication libraries. WebQoS is less efficient since it manages requests at a later processing stage (after they reach user-space).

Operating System Mechanisms for Overload Defense and Differential QoS Due to the inefficiencies of user-space software and the lack of cooperation from legacy applications, various OS-based solutions for the QoS management problem have been suggested. OS-level QoS management solutions do not require application cooperation, and they strictly enforce the configured QoS.

The Scout OS provides a path abstraction, which allows all OS activity to be charged to the resource budget of the application that triggered it. When network packets are received, for example, they are associated with a path as soon as their path affiliation is recognized by the OS; they are then handled using the resources that are available to that path. Unfortunately, to be effective, Scout's novel path abstraction must be used directly by the applications. Moreover, Scout and the other OS-based QoS management solutions must be configured in terms of raw resource reservations, i.e., they do not manage Internet services on the more natural per request-level. However, these solutions provide very fine-grained resource controls but require significant changes to current OS designs.

Mogul's and Ramakrishnan's work on the receive livelock problem has been a great inspiration to the design of Qguard. Servers may suffer from the receive livelock problem if their CPU and interrupt handling mechanisms are too slow to keep up with the interrupt stream caused by incoming packets. They solve the problem by making the OS slow down the interrupt stream (by polling or NIC-based interrupt mitigation), thus reducing the number of context switches and unnecessary work. They also show that a monitoring-based solution that uses interrupt mitigation only under perceived overload maximizes throughput. However, their work only targets receive-livelock avoidance and does not consider the problem of providing QoS differentiation—an important feature for today's Internet servers.

Network-Centric QoS Differentiation

Network-centric solutions for QoS differentiation is becoming the solution of choice. This is due to the fact that they are even less intrusive than OS-based solutions. They are completely transparent to the server applications and server OSs. This eases the integration of QoS management solutions into standing server setups. Some network centric-solutions are designed as their own independent network devices, whereas others are kernel-modules that piggy-back to the server's NIC driver.

Among the network-centric solutions is NetGuard's Guardian, which is QGuard's closest relative. Guardian, which implements the firewalling solution on the MAC-layer, offers user-level tools that allow real-time monitoring of incoming traffic. Guardian policies can be configured to completely block misbehaving sources. Unlike QGuard, Guardian's solution is not only static but also lacks the QoS differentiation since it only implements an all-or-none admission policy.

In general, remedies that have been proposed to improve server behavior under overload require substantial changes to the operating system or applications, which is unacceptable to businesses that only want to use the tried and true.

U.S. Pat. No. 5,606,668 to Shwed discloses a system which attempts to filter attack traffic that matches predefined configurations.

U.S. Pat. No. 5,828,833 to Belville et al. discloses a system which allows correct network requests to proceed through the filtering device. The system validates RPC calls and places the authentication information for the call in a filter table, allowing subsequent packets to pass through the firewall.

U.S. Pat. No. 5,835,726 to Shwed et al. discloses a system which utilizes filter rules to accept or reject types of network traffic at a set of distributed computing devices in a network (a firewall).

U.S. Pat. No. 5,884,025 to Baehr et al. discloses a system for packet filtering of data packet at a computer network interface.

U.S. Pat. No. 5,958,052 to Bellovin et al. discloses a system which possibly modifies a request distribution (in this case DNS request system strips outbound requests of information, thus keeping the original requestor's network information private).

### SUMMARY OF THE INVENTION

An aspect of the present invention is an efficient (i.e., low overload) method and system for controlling network traffic to a network computer.

Another aspect of the present invention is a method and system for controlling network traffic to a network computer to enable fast recovery from attacks such as DoS attacks.

Still another aspect of the present invention is a method and system for controlling network traffic to a network computer to enable automatic resource allocation differentiating preferred customers from non-preferred customers.

In carrying out the above aspects and other aspects of the present invention, a method for controlling network traffic to a network computer which provides network computer services is provided. The method includes measuring capacity of the network computer to service the network traffic to obtain a signal. The method also includes providing a set of rule data which represents different policies for servicing the network traffic, and selecting a subset of the rule data based on the signal. The method still further includes throttling the network traffic to the network computer based on the selected subset of the rule data wherein services provided by the network computer are optimized without overloading the network computer.

The network computer may be a server and wherein the network traffic includes requests for service from network clients over the network. The network may be the Internet and the server may be an Internet server.

The network traffic may include denial of service attacks.

The method may further include organizing the set of rule data in at least one multi-dimensional coordinate system. The capacity of the network computer may include load components or load component indices. The dimensions of the at least one multi-dimensional coordinate system may correspond to the load components or load component indices.

The method may further include the step of classifying network traffic to the network computer to obtain a plurality of traffic classifications and wherein the step of throttling is based on the plurality of traffic classifications.

The selected subset of rule data may represent quality of service differentiations and wherein the network traffic is throttled so that the network computer provides quality of service differentiation.

The step of throttling may prevent substantially all of the network traffic from reaching the network computer.

The step of throttling may allow substantially all of the network traffic to reach the network computer.

Further in carrying out the above aspects and other aspects of the present invention, a system for controlling network traffic to a network computer which provides network computer services is provided. The system includes a monitor for measuring capacity of the network computer to service the network traffic to obtain a signal. Storage is provided for storing a set of rule data which represents different policies for servicing the network traffic. The system further includes means for selecting a subset of the rule data based on the signal. A controller controls the network traffic to the network computer based on the selected subset of rule data. The services provided by the network computer are optimized without overloading the network computer.

The network computer may be a server and wherein the network traffic includes requests for service from network clients over the network. The network may be the Internet and the server may be an Internet server.

The network traffic may include denial of service attacks.

The set of rule data may be stored in at least one multi-dimensional coordinate system. The capacity of the network computer may include local components or local component indices and wherein the dimensions of the at least one multi-dimensional coordinate system corresponds to the load components or load component indices.

The system may further include a classifier for classifying network traffic to the network computer to obtain a plurality of traffic classifications and wherein the controller controls the network traffic based on the plurality of traffic classifications.

The selected subset of rule data may represent quality of service differentiations and wherein the network traffic is throttled so that the network computer provides quality of service differentiation.

The controller may prevent substantially all of the network traffic from reaching the network computer.

The controller may allow substantially all of the network traffic to reach the network computer.

The method and system of the present invention provide differential QoS, and protection from overload and some DoS attacks. The method and system are adaptive to exploit rate controls for inbound traffic in order to fend off overload and provide QoS differentiation between competing traffic classes.

The method and system provide freely configurable QoS differentiation (preferred customer treatment and service differentiation) and effectively counteract SYN and ICMP-flood attacks. Since the system preferably is a purely network-centric mechanism, it does not require any changes to server applications and can be implemented as a simple add-on module for any OS.

The system of the present invention is a novel combination of kernel-level and middleware overload protection mechanisms. The system learns the server's request-handling capacity independently and divides this capacity among clients and services according to administrator-specified rules. The system's differential treatment of incoming traffic protects servers from overload and immunizes the server against SYN-floods and the so-called “ping-of-death.” This allows service providers to increase their capacities gradually as demand grows since their preferred customer's QoS is not at risk. Consequently, there is no need to build up excessive over-capacities in anticipation of transient request spikes. Furthermore, studies on the load patterns observed on Internet servers show that over-capacities can hardly protect servers from overload.

The above aspects and other aspects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a block diagram illustrating the architecture of the system of the present invention;

FIG. 2 is a block diagram illustrating the classification of incoming traffic;

FIG. 3 is a chart illustrating a sample filter-hierarchy;

FIG. 4 is a block diagram flow chart illustrating a firewall entry of the present invention;

FIG. 5 is a schematic diagram illustrating the monitor's notification mechanism;

FIG. 6 is a schematic diagram illustrating a load controller of the present invention;

FIG. 7 is a graph of quantization internal versus normalized input rate illustrating the compressor function for q=½; and

FIG. 8 is a state transition diagram for the identification of misbehaving traffic classes.

### DETAILED DESCRIPTION OF THE PREFERRED EMBODIMENTS

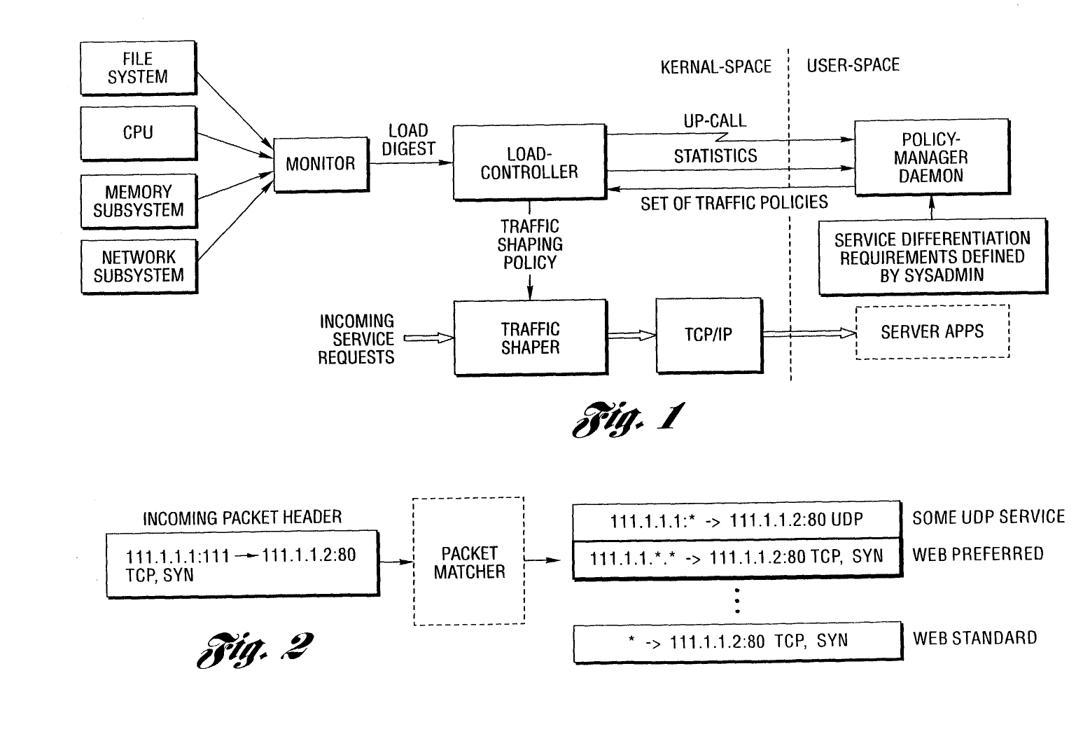

As previously noted, Internet servers suffer from overload because of the uncontrolled influx of requests from network clients. Since these requests for service are received over the network, controlling the rate at which network packets may enter the server is a powerful means for server load management. The method and system of the present invention exploit the power of traffic shaping to provide overload protection and differential service for Internet servers. By monitoring server load, the invention can adapt its traffic shaping policies without any a priori capacity analysis or static resource reservation. This is achieved by the cooperation of the four preferred components of the system of the invention as shown in FIG. 1: a traffic shaper, a monitor, a load-controller, and a policy manager.

Traffic Shaper

The method and system of the present invention rely on shaping the incoming traffic as its only means of server control. Since the invention promises QoS differentiation, differential treatment begins in the traffic shaper, i.e., simply controlling aggregate flow rates is oftentimes not good enough.

To provide differentiation, the traffic shaper associates incoming packets with their traffic classes. Traffic classes may represent specific server-side applications (IP destinations or TCP and UDP target ports), client populations (i.e., a set of IP addresses with a common prefix), DiffServ bits, or a combination thereof. Traffic classes should be defined to represent business or outsourcing needs. For example, if one wants to control the request rate to the HTTP service, a traffic class that aggregates all TCP-SYN packets sent to port 80 on the server should be introduced. This notion of traffic classes is commonly used in policy specifications for firewalls and was proposed initially by others. FIG. 2 displays a sample classification process. Once the traffic class is defined, it may be policed.

For effective traffic management, traffic classification and policing are combined into rules or policies. Each rule specifies whether a traffic class' packets should be accepted or dropped. Thus, it is possible to restrict certain IP domains from accessing certain (or all) services on the server while granting access to others without affecting applications or the OS. As far as the client and servers OS's are concerned, certain packets simply get lost. Such all-or-nothing scheme are used for server security (firewalls). However, for load-control, more fine-grained traffic control is necessary. Instead of tuning out a traffic source completely, the invention allows the administrator to limit its packet rate. Thus, preferred clients can be allowed to submit requests at a higher rate than non-preferred ones. Moreover, the invention also associates a weight representing traffic class priority with each rule. These prioritized, rate-based rules are referred to as rules or policies of the invention. These rules accept a specific traffic class' packets as long as their rate does not exceed the maximal rate specified in the rule. Otherwise, such a rule will cause the incoming packets to be dropped.

These rules can be combined to provide differential QoS. For example, the maximal acceptance rate of one traffic class can be set to twice that of another, thus delivering a higher QoS to the clients belonging to the traffic class identified by the rule with the higher acceptance rate. The combination of several rules of the invention—the building block of QoS differentiation—is called a filter of the invention (henceforth, filter). They may consist of an arbitrary number of rules. Filters are the inbound equivalent of CBQ polices.

The Monitor

Since the invention does not assume to know the ideal shaping rate for incoming traffic, it must monitor server load to determine it. Online monitoring takes the place of offline system capacity analysis.

The monitor is loaded as an independent kernel-module to sample system statistics. At this time, the administrator may indicate the importance of different load-indicators for the assessment of server overload. The monitoring module itself assesses server capacity based on its observations of different load indicators. Accounting for both the importance of all load indicators and the system capacity, the monitor computes the server load-index. Other kernel modules may register with the monitor to receive a notification if the load-index falls into a certain range.

Since the monitor drives the invention's adaptation to overload, it must be executed frequently. Only frequent execution can ensure that it will not miss any sudden load surges. However, it is difficult to say exactly how often it should sample the server's load indicators because the server is subject to many unforeseeable influences, e.g., changes in server popularity or content. Therefore, all relevant load indicators should be oversampled significantly. This requires a monitor with very low runtime overheads. The important role of the monitor also requires that it must be impossible to cause the monitor to fail under overload. As a result of these stringent performance requirements, it was decided that the logical place for the monitor is inside the OS.

The Load-Controller

The load-controller is an independent kernel-module, for similar reasons as the monitor, that registers its overload and underload handlers with the monitor when it is loaded into the kernel. Once loaded, it specifies to the monitor when it wishes to receive an overload or underload notification in terms of the server load-index. Whenever it receives a notification from the monitor, it decides whether it is time to react to the observed condition or whether it should wait a little longer until it becomes clear whether the overload or underload condition is persistent.

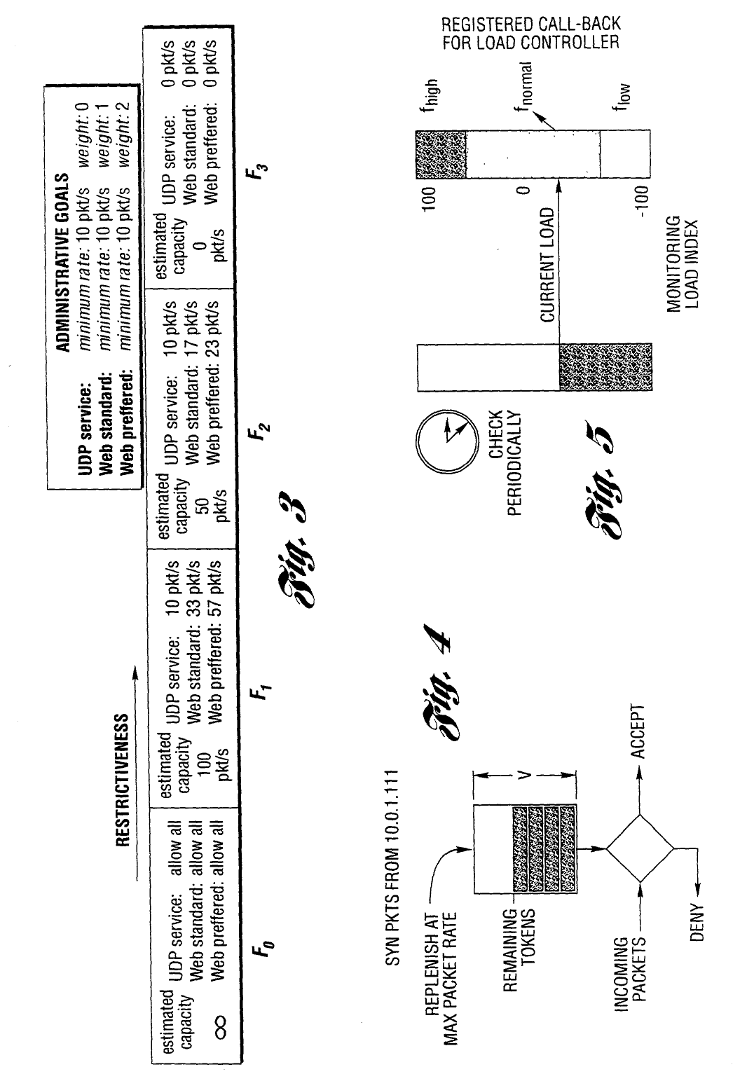

The load-controller is the core component of the invention's overload management. This is due to the fact that one does not know in advance to which incoming rate the packets of individual traffic classes should be shaped. Since one filter is not enough to manage server overload, the concept of a filter-hierarchy (FH) is introduced. A FH is a set of filters ordered by filter restrictiveness (shown in FIG. 3). These filter-hierarchies can be loaded into the load-controller on demand. Once loaded, the load-controller will use monitoring input to determine the least restrictive filter that avoids server overload.

The load-controller strictly enforces the filters of the FH, and any QoS differentiation that are coded into the FH in the form of relative traffic class rates will be implemented. This means that QoS-differentiation will be preserved in spite of the load-controllers dynamic filter selection.

Assuming an overloaded server and properly set up FH, i.e.,

all filters are ordered by increasing restrictiveness,

the least restrictive filter does not shape incoming traffic at all,

and the most restrictive filter drops all incoming traffic,

the load-controller will eventually begin to oscillate between two adjacent filters. This is due to the fact that the rate limits specified in one filter are too restrictive and not restrictive enough in the other.

Oscillations between filters are a natural consequence of the load-controller's design. However, switching between filters causes some additional OS overhead. Therefore, it is advantageous to dampen the load-controller's oscillations as it reaches the point where the incoming traffic rate matches the server's request handling capacity. Should the load-controller begin to oscillate between filters of vastly different acceptance rates, the FH is too coarse-grained and should be refined. This is the policy manager's job. To allow the policy manager to deal with this problem, the load-controller keeps statistics about its own behavior.

Another anomaly resulting from ineffective filter-hierarchies occurs when the load-controller repeatedly switches to the most restrictive filter. This means that no filter of the FH can contain server load. This can either be the result of a completely misconfigured FH or due to an attack. Since switching to the most restrictive policy results in a loss of service for all clients, this condition should be reported immediately. For this reason, the load-controller implements an up-call to the policy manager (FIG. 1). This notification is implemented as a signal.

The Policy Manger

The policy manager fine-tunes filter-hierarchies based on the effectiveness of the current FH. A FH is effective if the load-controller is stable, i.e., the load-controller does not cause additional traffic burstiness. If the load-controller is stable, the policy manager does not alter the current FH. However, whenever the load-controller becomes unstable, either because system load increases beyond bounds or because the current FH is too coarse-trained, the policy manager attempts to determine the server's operating point from the oscillations of the load-controller, and reconfigures the load-controller's FH accordingly.

Since the policy manager focuses the FH with respect to the server's operating point, it is the crucial component to maximizing throughput during times of sustained overload. It creates a new FH with fine-granularity around the operating point, thus reducing the impact of the load-controller's oscillations and adaptation operations.

The policy manager creates filter-hierarchies in the following manner. The range of all possible acceptance rates that the FH should cover—an approximate range given by the system administrator—is quantized into a fixed number of bins, each of which is represented by a filter. While the initial quantization may be too coarse to provide accurate overload protection, the policy manager successively zooms into smaller quantization intervals around the operating point. The policy manager's estimate of the operating points is called the focal point. By using non-linear quantization functions around this focal point, accurate, fine-grained control becomes possible. The policy manager dynamically adjusts its estimate of the focal point as system load or request arrival rates change.

The policy manager creates filter-hierarchies that are fair in the sense of max-min fair-share resource allocation. This algorithm executes in two stages. In the first stage, it allocates the minimum bandwidth to each rule. It then allocates the remaining bandwidth based on a weighted fair share algorithm. This allocation scheme has two valuable features. First, it guarantees a minimum bandwidth allocation for each traffic class (specified by the administrator). Second, excess bandwidth is shared among traffic classes based on their relative importance (also specified by the administrator). FIG. 3 shows an example FH that was created in this manner. This figure shows that the policy manager makes two exceptions from the max-min fair-share rule. The leftmost filter admits all incoming traffic to eliminate the penalty for the use of traffic shaping on lightly-loaded servers. Furthermore, the rightmost filter drops all incoming traffic to allow the load-controller to drain residual load if too many requests have already been accepted.

There are some situations that cannot be handled using the outlined successive FH refinement mechanism. Such situations often result from DoS attacks. In such cases, the policy manager attempts to identify ill-behaved traffic classes in the hope that blocking them will end the overload. To identify the ill-behaved traffic class, the policy manager first denies all incoming requests and admits traffic classes one-by-one on a probational basis (FIG. 8) in order of their priority. All traffic classes that do not trigger another overload are admitted to the server. Other ill-behaved traffic classes are tuned out for a configurable period of time (typically a very long time).

Since the policy manager uses floating point arithmetic and reads configurations from the user, it is implemented as a user-space daemon. This also avoids kernel-bloating. This is not a problem because the load-controller already ensures that the system will not get locked-up. Hence, the policy manager will always get a chance to run.

Implementation

The Traffic Shaper

Linux provides sophisticated traffic management for outbound traffic inside its traffic shaper modules. Among other strategies, these modules implement hierarchical link-sharing. Unfortunately, there is nothing comparable for inbound traffic. The only mechanism offered by Linux for the management of inbound traffic is IP-Chains—a firewalling module. The firewalling code is quite efficient and can be modified easily. Furthermore, the concept of matching packet headers to find an applicable rule for the handling of each incoming packet is highly compatible with the notion of a rule of the invention. The only difference between rules of the invention and IP-Chains' rules is the definition of a rate for traffic shaping. Under a rate-limit, a packet is considered to be admissible only if the arrival rate of packets that match the same header pattern is lower than the maximal arrival rate.

The rules of the invention are fully compatible with conventional firewalling policies. All firewalling policies are enforced before the system checks the rules. This means that the system with the invention will never admit any packets that are to be rejected for security reasons.

The traffic shaping implementation of the invention follows the well-known token bucket rate-control scheme. Each rule is equipped with a counter (remaining_tokens), a per-second packet quota, and a time-stamp to record the last token replenishment time. The remaining_tokens counter will never exceed V×quota with V representing the bucket's volume.

The Linux-based IP-Chains firewalling code is modified as follows. The matching of an incoming packet against a number of packet header patterns for classification purposes (FIG. 2) remains unchanged. At the same time, the invention looks up the traffic class' quota, time-stamp, and remaining_tokens and executes the token bucket algorithm to shape incoming traffic. For instance, it is possible to configure the rate at which incoming TCP-SYN packets from a specific client should be accepted. The following command:

qgchains -A qguard --protocol TCP --syn --destination-port --source 10.0.0.1 -j RATE 2

allows the host 10.0.0.1 to connect to the web server at a rate of two requests per second. The syntax of this rule matches the syntax of Linux IP-Chains, which is used for traffic classification. Packets are chosen as the unit of control because one is ultimately interested in controlling the influx of requests. Usually, requests are small and, therefore, sent in a single packet. Moreover, long-lived streams (e.g., FTP) are served well by the packet-rate abstraction, too, because such sessions generally send packets of maximal size. Hence, it is relatively simple to map byte-rates to packet-rates.

The Monitor

The Linux OS collects numerous statistics about the system state, some of which are good indicators of overload conditions. A lightweight monitoring module is implemented that links itself into the periodic timer interrupt run queue and processes a subset of Linux's statistics (Table 1). Snapshots of the system are taken at a default rate of 33 Hz. While taking snapshots, the monitor updates moving averages for all monitored system variables.

TABLE 1
Load Indicators Used in the Linux Implementation

| Indicator | Meaning |
|---|---|
| High paging rate | Incoming requests cause high memory |
| | consumption, thus severely limiting |
| | system performance through paging. |
| High disk access rate | Incoming requests operate on a dataset |
| | that is too large to fit into the file cache. |
| Little idle time | Incoming requests exhaust the CPU. |
| High outbound traffic | Incoming requests demand too much |
| | outgoing bandwidth, thus leading to |
| | buffer overflows and stalled server |
| | applications. |
| Large inbound packet backlog | Requests arrive faster than they can be |
| | handled, e.g., flood-type attacks. |
| Rate of timeouts for TCP | SYN-attacks or network failure. |
| connection requests | |

When loading the monitoring module into the kernel, the superuser specifies overload and underload conditions in terms of thresholds on the monitored variables, the moving averages, and their rate of change. Moreover, each monitored system variable, xᵢ, may be given its own weight, wᵢ. The monitor uses overload and underload thresholds in conjunction with the specified weights to compute the amalgamated server load index—akin to Steere's “progress pressure.” To define the server load index formally, the overload indicator function, Iᵢ(Xᵢ) is introduced, which operates on the values of monitored variables and moving averages, Xᵢ:

$${I}_{i} , ( {X}_{i} ) = \{ \begin{matrix}1 & if {X}_{i} indicates an overload condition \\ - 1 & if {X}_{i} indicates an underload condition \\ 0 & otherwise\end{matrix}$$

For n monitored system variables, the monitor computes the server load index as

$${\sum }_{i = 1}^{n} {I}_{i} ( {X}_{i} ) .$$

Once this value has been determined, the monitor checks whether this values falls into a range that triggers a notification to other modules (see FIG. 5). Modules can simply register for such notifications by registering a notification range [a, b] and a callback function of the form

void (* callback) (int load_index)

with the monitor. In particular, the load-controller—to be described in the following section—uses this monitoring feature to receive overload and underload notifications.

Since the server's true capacity is not known before the server is actually deployed, it is difficult to define overload and underload conditions in terms of thresholds on the monitored variables. For instance, the highest possible file-system access rate is unknown. If the administrator picks an arbitrary threshold, the monitor may either fail to report overload or indicate a constant overload. Therefore, the system is implemented to dynamically learn the maximal and minimal possible values for the monitored variables, rates of change, and moving averages. Hence, thresholds are not expressed in absolute terms but in percent of each variable's maximal rate. Replacing absolute values with percentage-based conditions improved the robustness of the implementations and simplified administration significantly.

The Load-Controller

The invention's sensitivity to load-statistics is an important design parameter. If too sensitive, it will never settle into a stable state. On the other hand, if too insensitive to server load, it will fail to protect it from overload. For good control of sensitivity, three different control parameters are introduced:

1. The minimal sojourn time, s, is the minimal time between filter switches. Obviously, it limits the switching frequency.

2. The length of the load observation history, h, determines how many load samples are used to determine the load average. The fraction l/h is the grain of all load-measurement. For example, a history of length 10 allows load measurements with 10% accuracy.

3. A moderator value, m, is used to dampen oscillations when the shaped incoming packet rate matches the server's capacity. To switch to a more restrictive filter, at least m times more overloaded than underloaded time intervals have to be observed. This means that the system's oscillations die down as the target rate is reached, assuming stable offered load.

Small values for m (3-6) serve this purpose reasonably well. Since both s and m slow down oscillations, relatively short histories (h ε[5,15]) can be used in determining system load. This is due to the fact that accurate load assessment is necessary only if the server operates close to its operating point. Otherwise, overload and underload are obvious even when using less accurate load measurements. Since the moderator stretches out the averaging interval as the system stabilizes, measurement accuracy is improved implicitly. Thus, the invention maintains responsiveness to sudden load-shifts and achieves accurate load-control under sustained load.

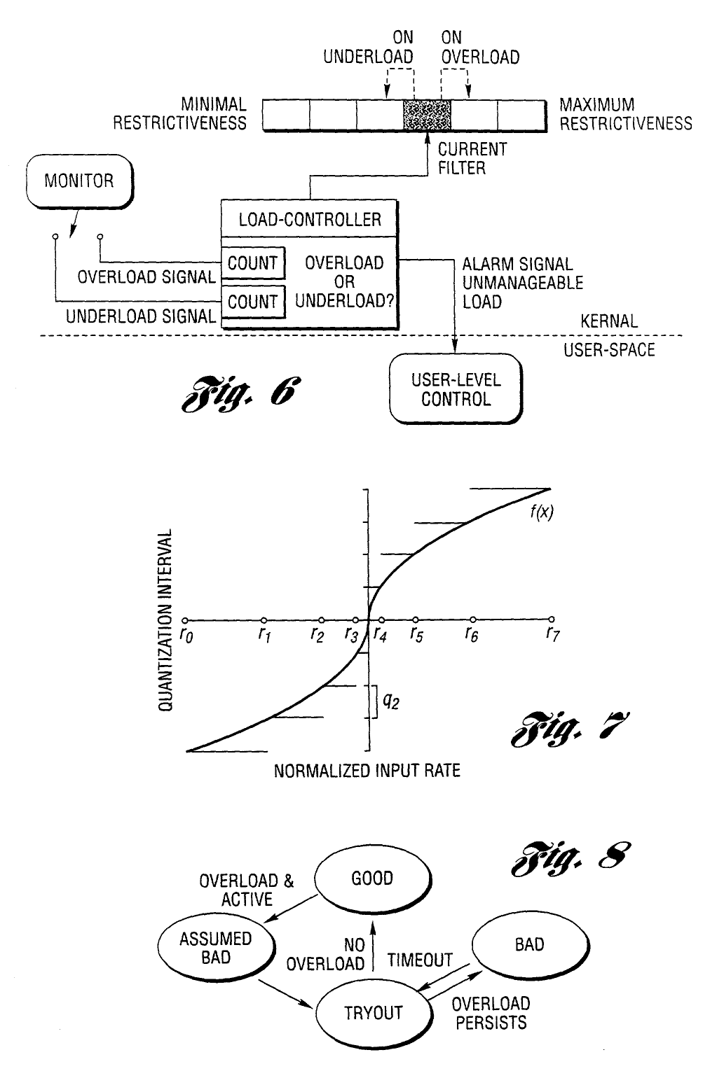

For statistical purposes and to allow refinement of filter hierarchies, the load-controller records how long each filter was applied against the incoming load. Higher-level software, as described below, can query these values directly using the new QUERY_QGUARD socket option. In response to this query, the load-controller will also indicate the most recent load condition (e.g., CPU_OVERLOAD) and the currently deployed filter (FIG. 6).

The load-controller signals an emergency to the load-controller whenever it has to switch into the most restrictive filter (drop all incoming traffic) repeatedly to avoid overload. Uncontrollable overload can be a result of:

1. ICMP floods;

2. CPU intensive workloads;

3. SYN attacks;

4. Congested inbound queues due to high arrival rate;

5. Congested outbound queues as a result of large replies;

6. The onset of paging and swapping; and

7. File system request overload.

To avoid signaling a false uncontrollable overload, which happens when the effects of a previous overload are still present, the system learns the time, t, that it takes for the system to experience its first underload after the onset of an overload. The time t indicates how much system load indicators lag behind control actions. If 2t>s (sojourn time, s), the t/2 is used in place of the minimal sojourn time. Thus, in systems where the effects of control actions are delayed significantly, the load-controller waits for a longer time before increasing the restrictiveness of inbound filters. Without the adaptation of minimal sojourn times, such a system would tend to oversteer, i.e., drop more incoming traffic than necessary. This problem occurs whenever server applications queue up large amounts of work internally. Server applications that decouple workload processing from connection management are a good example (e.g., the Apache Web server). However, if per-request work is highly variant, the invention fails to stabilize. In such cases, a more radical solution like LRP becomes necessary.

The Policy Manager

The policy manager implements three different features. First, it performs statistical analysis to dynamically adjust the granularity of the FH and estimates the best point of operation. Second, it identifies and reacts to sustained overload situations and tunes out traffic from malicious sources. Finally, it creates a FH that conforms to the service differentiation requirements.

The policy manager views a FH as a set of n filters {F₀, F₁, . . . ,Fₙ}. As described above, filter Fₗ consists of a set of rules {r_{l,0},r_{i,1}, . . . ,r_{l,m}}. For convenience, some notation to represent different attributes of a filter is introduced.

| | |
|---|---|
| TIME(Fᵢ) | is the amount of time for which the load controller used Fᵢ to |
| | contain system load. This attribute can be directly read from |
| | the statistics of the load-controller. |
| RATE(Fᵢ) | is the rate at which Fᵢ accepts incoming packets. This is the |
| | sum of the rates given for all rules of the invention, j, that |
| | belong to the filter, RATE(Fᵢ, j). |

Since the invention provides fair-share-style resource allocation, the policy manager must create filter hierarchies where adjacent filters, Fᵢ and Fᵢ₊₁ satisfy the following: if a packet is admissible according to rule r_{i+1,j}, then it is also admissible according to rule r_{i,j}. However, the converse is not necessarily true. First, this implies that corresponding rules from different filters within a FH always specify the same traffic class. Second, RATE(Fᵢ₊₁,j)<RATE(F_{i,j}) for all j. Furthermore, F₀ always admits all and Fₙ drops all incoming traffic. The monotonicity of the rates in a filter-hierarchy is a result of the commitment to fair-share resource allocation.

The FH defined above guarantees that there is at least one filter, Fₙ, that can suppress any overload. Moreover, if there is no overload, no packet will be dropped by the load-controller because F₀ admits all packets. Depending on the amount of work that it takes to process each request and the arrival rate of requests, the load-controller will oscillate around some filter near the operating point of the system, i.e., the highest incoming rate that does not generate an overload. Since the rate difference between filters is discrete, it is unlikely that there is one particular filter that shapes incoming traffic exactly to the optimal incoming rate. Therefore, it is necessary to refine the FH. To construct the ideal filter F* that would shape incoming traffic to the maximal request arrival rate of the server, the policy manager computes the focal point (FP) of the load-controller's oscillations:

$$FP := \frac{{\sum }_{i = 1}^{n} TIME ( {F}_{i} ) * RATE ( {F}_{i} )}{{\sum }_{i = 1}^{N} TIME ( {f}_{i} )}$$

Whether or not the policy manager uses a finer quantization around the focal point depends on the load-controller's stability (absence of oscillations covering many filters). To switch between different quantization grains, the policy manager uses a family of compressor functions that have the following form:

$${f}_{q} ( x - FP ) = \{ \begin{matrix}{( x - FP )}^{q} & for x \geq FP \\ - {( FP - x )}^{q} & for x < FP\end{matrix}$$

An experimental configuration only used f_{q}(x) for q={1,½,⅓}; FIG. 7 shows f/_{½}(x). The horizontal lines reflects the quantization of the same function based on 8 quantization levels (the dashes on the y-axis). The ranges for each interval, marked on the x-axis illustrate how their widths become smaller as they approach the focal point. Therefore, one only needs to decrease q to achieve higher resolution around the focal point. To compute the range values of each quantization interval, the inverse function (a polynomial) is applied. This is illustrated by the shaded area in FIG. 7.

Under the assumption that the future will resemble the past, compression functions should be picked to minimize the filtering loss that results from the load-controller's oscillations. However, this requires keeping long-term statistics, which in turn requires a large amount of bookkeeping. Instead of bookkeeping, a fast heuristic is chosen that selects the appropriate quantization, q, based on the load-controller's statistics. Simply put, if the load-controller only applies a small number of filters over a long time, a finer resolution is used. More specifically, if the load-controller is observed to oscillate between two filters, it is obvious that the filtering-grain is too coarse and a smaller q is used. It was found that it is good to switch to a smaller q as soon as the load-controller is found oscillating over a range of roughly 4 filters.

When a new FH is installed, the load-controller has no indication as to which filter it should apply against incoming traffic. Therefore, the policy manager advances the load-controller to the filter in the new FH that shapes incoming traffic to the same rate as the most recently used filter from the previous FH. The policy manager does not submit a new FH to the load-controller if the new hierarchy does not differ significantly from the old one. A change is significant if the new FP differs more than 5% from the previous one. This reduces the overheads created by the policy manager, which includes context switches and the copying of an entire FH.

The above computations lead to improved server throughput under controllable overload. However, if the load-controller signals a sustained (uncontrollable) overload, the policy manager identifies misbehaving sources as follows (see also FIG. 8).

Assumed Bad: Right after the policy manager recognizes that the load-controller is unable to contain the overload, each traffic class is labeled as potentially bad. In this state, the traffic class is temporarily blocked.

Tryout: Traffic classes are admitted one-by-one and in priority order. A “tryout-admission” is probational and used to identify whether a given traffic class is causing the overload.

Good: A traffic class that passed the “tryout” state without triggering an overload is considered to be “good.” It is admitted unconditionally to the system. This is the normal state for all well-behaved traffic classes.

Bad: A traffic class that triggered another overload while being tried out is considered to be a “bad” traffic class. Bad traffic classes remain completely blocked for a configurable amount of time.

To avoid putting traffic classes on trial that are inactive, the policy manager immediately advances such traffic classes from state “tryout” to “good.” All other traffic classes must undergo the standard procedure. Unfortunately, it is impossible to start the procedure immediately because the server may suffer from residual load as a result of the attack. Therefore, the policy manager waits until the load-controller settles down and indicates that the overload has passed.

The problem of delayed overload effects became evident in the context of SYN-flood attacks. If Linux 2.2.14 is used as the server OS, SYN packets that the attacker places in the pending connection backlog queue of the attacked server take 75 s to time out. Hence, the policy manager must wait at least 75 s after entering the recovery procedure for a SYN-attack. Another wait may become necessary during the recovery period after one of the traffic classes revealed itself as the malicious source because the malicious source had a second chance to fill the server's pending connection backlog.

The above-described prototype of the invention requires the addition of kernel modules to the Internet server's OS. However, it is to be understood that the invention can be built into a separate firewalling/QoS-management device. Such a device would be placed in between the commercial server and the Internet, thus protecting the server from overload. Such a set-up could necessitate changes in the above-described monitoring architecture. A SNMP-based monitor may be able to deliver sufficiently up-to-date server performance digests so that the load-controller can still protect the server from overload without adversely affecting server performance.

The method and system of the invention may be embedded entirely on server NICs. This would provide the ease of plug-and-play, avoid an additional network hop (required for a special front end), and reduce the interrupt load placed on the server's OS by dropping packets before an interrupt is triggered. Another advantage of the NIC-based design over the prototype described above is that it would be a completely OS-independent solution.

In summary, the method and system of the present invention achieve both protection from various forms of overload attacks and differential QoS using a simple monitoring control feedback loop. Neither the core networking code of the OS nor applications need to be changed to benefit from the invention's overload protection and differential QoS. The invention delivers good performance even though it uses only inbound rate controls. The invention's relatively simple design allows decoupling QoS issues from the underlying communication protocols and the OS, and frees applications from the QoS-management burden. In the light of these great benefits, it is believed that inbound traffic controls will gain popularity as a means of server management.

While the best modes for carrying out the invention have been described in detail, those familiar with the art to which this invention relates will recognize various alternative designs and embodiments for practicing the invention as defined by the following claims.

What is claimed is:

1. A method for controlling network traffic to a network computer which provides network computer services, the method comprising:
measuring capacity of the network computer to service the network traffic to obtain a signal;
providing a set of rule data which represents different policies for servicing the network traffic;
selecting a subset of the rule data based on the signal; and
throttling the network traffic to the network computer based on the selected subset of the rule data wherein services provided by the network computer are optimized without overloading the network computer.

2. The method as claimed in claim 1 wherein the network computer is a server and wherein the network traffic includes requests for service from network clients over the network.

3. The method as claimed in claim 2 wherein the network is the Internet and the server is an Internet server.

4. The method as claimed in claim 1 wherein the network traffic includes denial of service attacks.

5. The method as claimed in claim 1 further comprising organizing the set of rule data in at least one multi-dimensional coordinate system.

6. The method as claimed in claim 5 wherein the capacity of the network computer includes load components or load component indices and wherein the dimensions of the at least one multi-dimensional coordinate system corresponds to the load components or load component indices.

7. The method as claimed in claim 1 further comprising the step of classifying network traffic to the network computer to obtain a plurality of traffic classifications and wherein the step of throttling is based on the plurality of traffic classifications.

8. The method as claimed in claim 1 wherein the selected subset of rule data represents quality of service differentiations and wherein the network traffic is throttled so that the network computer provides quality of service differentiation.

9. The method as claimed in claim 1 wherein the step of throttling prevents substantially all of the network traffic from reaching the network computer.

10. The method as claimed in claim I wherein the step of throttling allows substantially all of the -network traffic to reach the network computer.

11. A system for controlling network traffic to a network computer which provides network computer services, the system comprising:
a monitor for measuring capacity of the network computer to service the network traffic to obtain a signal;
a storage for storing a set of rule data which represents different policies for servicing the network traffic;
means for selecting a subset of the rule data based on the signal; and
a controller for controlling the network traffic to the network computer based on the selected subset of rule data wherein the services provided by the network computer are optimized without overloading the network computer.

12. The system as claimed in claim 11 wherein the network computer is a server and wherein the network traffic includes requests for service from network clients over the network.

13. The system as claimed in claim 12 wherein the network is the Internet and the server is an Internet server.

14. The system as claimed in claim 11 wherein the network traffic includes denial of service attacks.

15. The system as claimed in claim 11 wherein the set of rule data is stored in at least one multi-dimensional coordinate system.

16. The system as claimed in claim 15 wherein the capacity of the network computer includes local components or local component indices and wherein the dimensions of the at least one multi-dimensional coordinate system corresponds to the load components or load component indices.

17. The system as claimed in claim 11 further comprising a classifier for classifying network traffic to the network computer to obtain a plurality of traffic classifications and wherein the controller controls the network traffic based on the plurality of traffic classifications.

18. The system as claimed in claim 11 wherein the selected subset of rule data represents quality of service differentiations and wherein the network traffic is throttled so that the network computer provides quality of service differentiation.

19. The system as claimed in claim 11 wherein the controller prevents substantially all of the network traffic from reaching the network computer.

20. The system as claimed in claim 11 wherein the controller allows substantially all of the network traffic to reach the network computer.
